(19) United States
(12) Patent Application Publication
(10) Pub. No.: US 2011/0091656 A1
(43) Pub. Date: Apr. 21, 2011

(54) CONNECTOR FOR A GRAVITY FEED SPRAY GUN, A GRAVITY FEED SPRAY GUN AND A METHOD OF PREPARING A SPRAY PAINT

(76) Inventor: Charles Julien, London (GB)

(21) Appl. No.: 12/997,953

(22) PCT Filed: Jun. 17, 2009
(86) PCT No.: PCT/GB09/50691

§ 371 Date: Dec. 14, 2010

(30) Foreign Application Priority Data
Jun. 17, 2008 (GB) 0811050.4

(51) Int. Cl. B05D 1/02; B05C 5/00

(52) U.S. Cl. 427/421.1; 118/300

(57) ABSTRACT

The present invention concerns a connector for connecting a paint container (1) having an aperture to a gravity feed spray paint gun. The connector comprises a coupling (7) for connection to the container's aperture and, in use, for mounting the container above the spray gun; a paint feed channel (10) for feeding paint from the container into the spray gun; and an air feed channel (13) for feeding air into the container as paint is fed into the spray gun.

The present invention relates to a connector for a gravity feed spray gun, to a gravity feed spray gun using such a connector, and to a method of preparing a spray paint.

Conventional spray painting apparatus, which are used for example for spray painting motor vehicles, comprise a spray gun and a paint hopper connected to the gun for feeding paint into the gun. Prior to spraying, the components of the paint (typically a solvent, a pigment, additives and a hardener) have to be measured out precisely and then mixed together in a separate mixing pot. The mixed paint is then poured into the hopper, which is fixed above the spray gun so that the paint is fed into the spray gun under gravity. The spray gun combines paint from the hopper with compressed air from a separate air compressor, which atomises the paint into a fine spray, and directs it to the target surface.

There are various problems with such conventional apparatus. In this connection, the paint components can be hazardous, and/or difficult to handle and mix. Accordingly, it is difficult and time consuming for a user to precisely measure out the exact quantities of the components required, mix the components properly, and then transfer them to the hopper provided on the spray gun. Furthermore, it can be difficult to fill the hopper with paint, as the spray gun must be held in one hand while the paint is poured from the mixing pot into the hopper. Moreover, once the paint has been sprayed, the user must clean the mixing pot, the hopper, and gun itself, before these components can be reused. This can be time consuming.

Accordingly, improvements to this conventional apparatus have included ways to simplify the mixing of the paint components, and the transfer the mixed paint to the hopper. Improvements have also focused on ways to simplify the cleaning of the spray gun after spray painting has been carried out.

In a known apparatus developed to improve on the conventional apparatus described above, the paint is mixed and poured into a liner bag placed inside the hopper. The use of a liner bag means that the hopper does not require cleaning after use, leaving only the spray gun requiring cleaning, which can be achieved by simply flushing a cleaning fluid through the spray gun. Nevertheless, this system still requires the user to measure out the precise quantities of the paint components and mix them, and fill the liner.

GB 290 866 concerns the adjustable control of air and paint conduits in a compressed air painting apparatus and provides an apparatus including a pressure pot, a nozzle and air and paint conduits.

US 2007/018016 concerns a liquid spraying assembly including a reservoir, a venting tube and a spray gun.

WO 2008/148887 concerns a self regulating vent for a paint supply vessel and provides a closure lid for closing a reservoir including an air inlet.

WO 2009/046806 concerns a cover for mixing containers for paint spray cans including a ventilation opening.

U.S. Pat. No. 6,698,670 concerns a friction fit paint cup connection and provides a cover-connector for covering and connecting a fluid supply container to a conduit.

The present invention seeks to address the above problems associated with the above known devices.

According to a first aspect of the present invention there is provided a connector for connecting a paint container having an aperture to a gravity feed spray paint gun, the connector comprising: a coupling for connection to the container's aperture and, in use, for mounting the container above the spray gun; a paint feed channel for feeding paint from the container into the spray gun; and an air feed channel for feeding air into the container as paint is fed into the spray gun.

In this way, the present invention can enable a standard or substantially standard off-the-shelf bottle-type container containing a paint to be directly connected to the spray gun and used to feed paint therefrom into the spray gun. This is because the present invention allows pressure in the container to be equalised as paint is fed into the spray gun. As such, the paint can be dispensed from a standard container which has only a single aperture, i.e. its spout. Consequently, the paint does not need to be transferred into a separate hopper. This is particularly important since it permits the use of a spray paint delivery system in which a container can be supplied with a required quantity of a first paint component (such as solvent, pigment, additives, and/or hardener, or a mixture thereof) already contained therein. The required amount of a second paint component, containing the remaining required component(s) of the paint, can then be simply added to the container. All the components of the paint can then be mixed together by shaking the container. Once the paint has been mixed, the container can then be directly connected to the spray gun. After use, the container can be detached and simply disposed of, leaving only the spray gun requiring cleaning. In this way, mixing of the paint components is simplified, exposure to the paint components is minimised, and the amount of cleaning is reduced. The present invention would also allow a pre-filled, ready mixed container of paint to be directly connected to the spray gun without having to decant the paint into a separate hopper.

Optionally, the air feed channel may comprise means for preventing paint from flowing out of the container though the air feed channel. This allows air to flow into the container in use while preventing paint from leaking out through the air feed channel.

Preferably, the means for preventing paint flow comprises a one-way valve.

Preferably, the connector may further comprise a tube for defining the air feed channel, the tube extending from the coupling such that, in use, it extends upward through the container's aperture into the container. This allows air to be admitted directly to the air cavity in the container above the paint level to equalise the pressure therein, without air having to pass though the paint. This ensures that paint is smoothly fed into the spray gun.

In a particularly preferred embodiment, the one-way valve comprises: first and second opposing panels, the first panel being flexible and being connected to said second panel at or adjacent its lateral edges, said panels abutting against one another for preventing fluid passing into the tube and being moveable relative to one another into an open position for forming a fluid channel for fluid connection between the tube and the interior of the container; and wherein, in use, when the air pressure in the tube exceeds the air pressure in the interior of the container, said panels move to the open position for opening said fluid channel.

In this way, first and second panels form closed lips which are able to gape open in order to open the fluid channel for equalizing the air pressure inside the container. Once the air pressure is equalised and the flow of paint from the container has stopped, the valve is then able to close under the action of the shape memory of the panel material and the air/fluid pressure acting on the external surfaces of the panels. As will be understood, the valve functions in a similar to a duckbill valve, allowing for smooth feeding of paint into the spray gun, whilst preventing paint from leaking out through the air feed channel. The simple construction employed by the above one-way valve provides a valve which is less prone to clogging, as compared to other one-way valve constructions, such as ball check valves. Furthermore, the simple construction also enables the valve to be manufactured cheaply, permitting the valve to be provided as a detachable, disposable component. This allows the valve to be thrown away and replaced when necessary.

Conveniently, the second panel is flexible. In this way, both the panels are provided as flexible, sheet-like elements, such that the fluid channel, once expanded, forms a tube.

Conveniently, the one-way valve further comprises a connector element provided between said first and second panels for connecting the tube to the fluid channel, wherein said connector element spaces said panels at their end closest to the tube, the panels being configured to taper inwardly towards their end distal to the connector element. In this way, the connector element forms a small cavity at the base of the valve, between the panels, which facilitates the opening of the panels when pressure builds inside the cavity, allowing the fluid channel to form.

Conveniently, the connections between the first and second panels taper inwardly from the end closest to the tube for forming a substantially conical tube when in an open, expanded, position.

In one embodiment, the first and second panels are integrally formed.

Preferably, the first and second panels are formed of a laminated foil.

In a preferred embodiment, the tube is configured such that, in use, it extends into the vertical extremity of the container. This ensures the end of the tube is positioned as far as possible above the level of paint held in the container. That is, when a container full of paint mix is connected to the connector and inverted, initially a small quantity of paint is fed into the spray gun, creating a small air cavity which rises to the most vertical portion of the container. By positioning the tube in the above way, its end extends into this air cavity, allowing the pressure to be equalised as more paint feeds out of the container. This ensures a smooth flow of paint, even when a full container is first used.

The connector may further comprise a filter situated in the paint feed channel. This prevents any impurities or congealed paint in the container or its paint mix from being fed to the spray gun, which could affect the quality of the spray painting.

The valve and/or tube and/or filter may be detachable from the adaptor. Thus the component parts of the spray painting system may be provided and replaced separately.

Conveniently, the coupling comprises a threaded connector for connection to standard or substantially standard threading provided on the container's aperture. This can allow an off-the-shelf, disposable container, to be easily connected to the connector, providing a simple and cost effective system.

According to a second aspect of the present invention there is provided a gravity feed spray gun comprising the connector according to the first aspect of the present invention.

According to a third aspect of the present invention there is provided a method of preparing a spray paint comprising the steps of: providing a container with a required amount of a first paint component contained therein; adding a required amount of a second paint component to the container; mixing the components in the container; mounting the container above the gravity feed spray gun using a connector, the connector comprising a coupling for connection to the container's aperture, a paint feed channel for feeding paint from the container into spray gun, and an air feed channel for feeding air into the container as paint is fed into the spray gun; and inverting the gun and container ready for spraying.

Conveniently, said first paint component comprises solvent, pigment, additives and/or hardener. Conveniently, said second paint component comprises solvent, pigment, additives and/or hardener.

According to a fourth aspect of the present invention there is provided a one-way valve comprising: an inlet for receiving a fluid; first and second opposing panels, each of said panels being formed of a flexible sheet and being connected to one another at or adjacent their lateral edges for forming a collapsible tube connected to said inlet; wherein said panels abut against one another for preventing fluid passing into the inlet; and wherein, in use, when the fluid pressure at the inlet exceeds the external fluid pressure, said panels are moveable to an open position for expanding said collapsible tube for permitting fluid to flow there through.

An example of the present invention will now be described with reference to the accompanying drawings in which:—

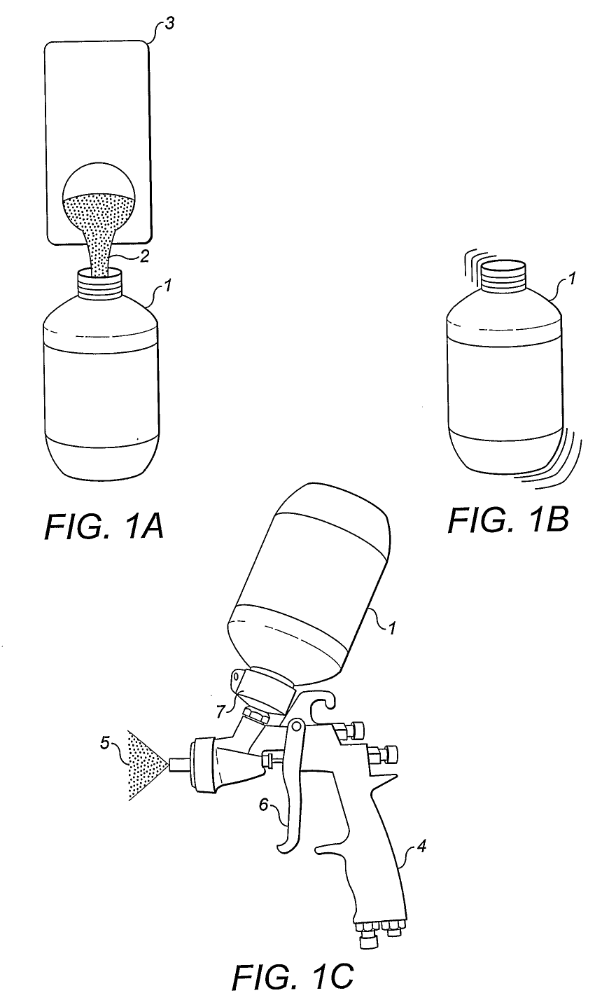

FIGS. 1A to 1C are a representation of the spray paint delivery system according to an embodiment of the present invention;

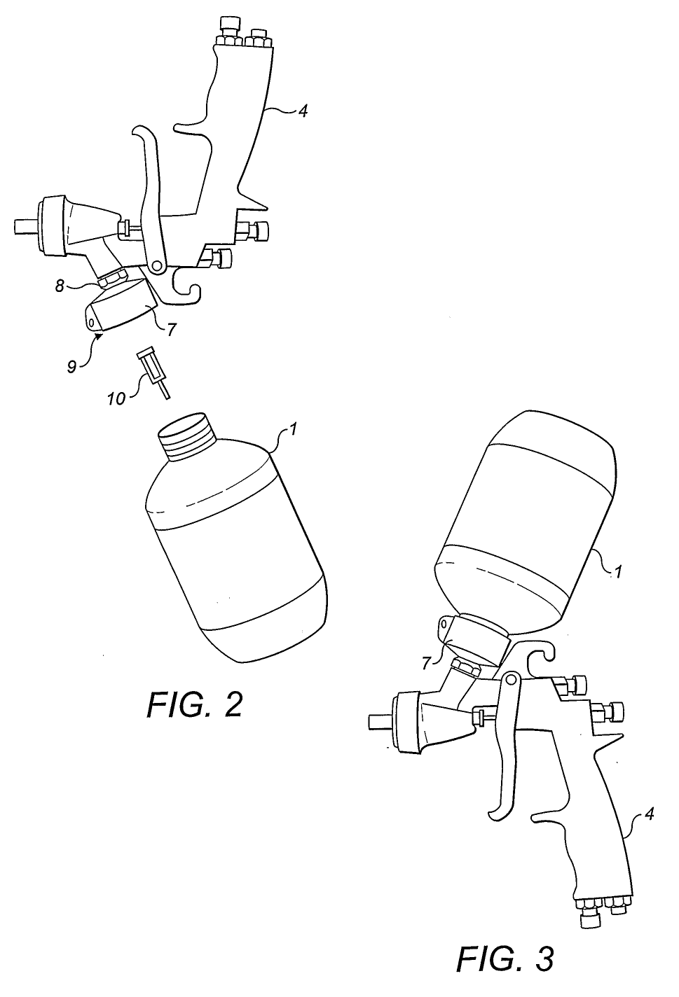

FIG. 2 is an exploded view of the spray gun and container according to a first embodiment of the present invention;

FIG. 3 shows the assembled components of the spray gun and container shown in FIG. 2;

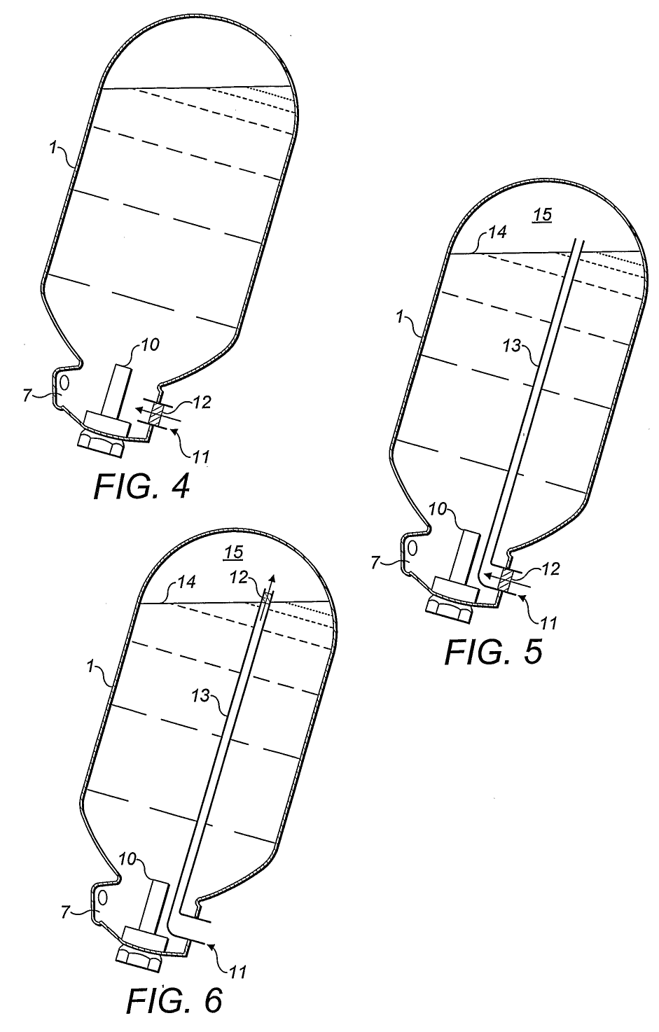

FIG. 4 shows a cross-sectional view of the container and adaptor according to the first embodiment of the invention;

FIG. 5 is a cross-sectional view of the container and adaptor according to a second embodiment of the invention;

FIG. 6 is a cross-sectional view of the container and adaptor according to a third embodiment of the invention;

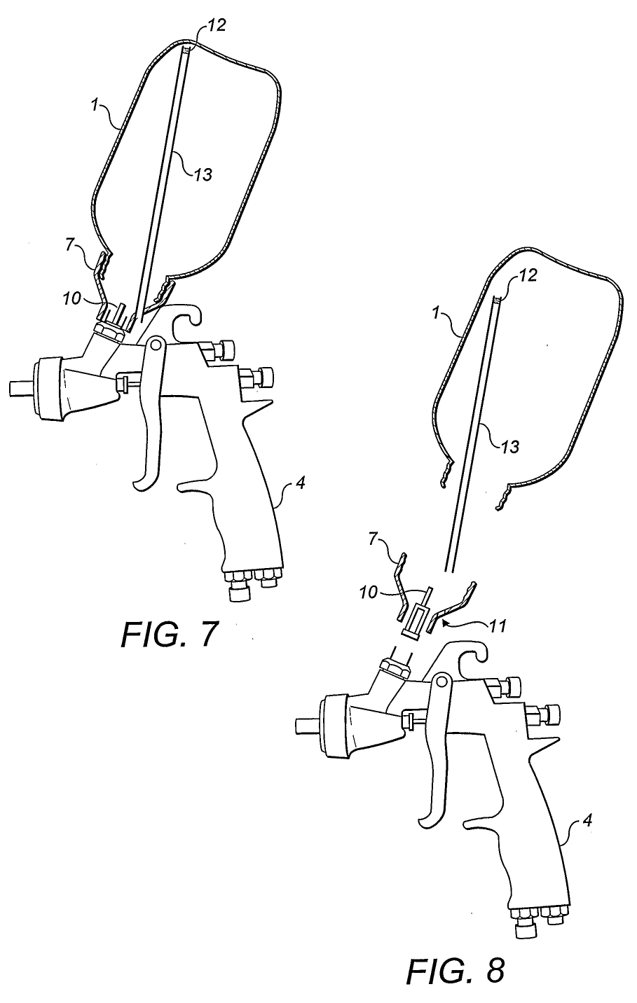

FIG. 7 is a cross-sectional view of the container and adaptor according to a fourth embodiment of the invention;

FIG. 8 is an exploded cross sectional view of the fourth embodiment as shown in FIG. 7;

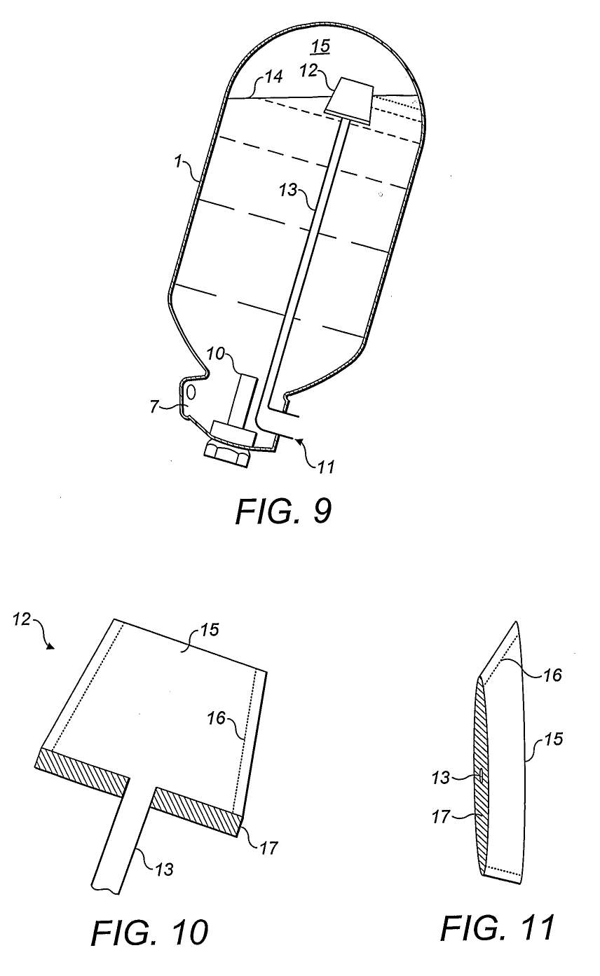

FIG. 9 is a cross-sectional view of the container and adaptor according to a fifth embodiment of the invention;

FIG. 10 shows a cross-sectional view of the one-way valve according to an embodiment of the present invention and as shown in FIG. 9; and

FIG. 11 shows an end view of the one-way valve shown in FIG. 10.

FIGS. 1A to 1C show a paint system according to an embodiment of the present invention for overcoming the problems associated with spray painting described above. Referring firstly to FIG. 1A, a container 1 itself is a standard or substantially standard off-the-self type container, having a threaded opening which can be closed by means of a standard or substantially standard threaded closure cap. In this system, the container 1 is supplied with the required amount of a first paint component already contained therein, which may include one or more of a solvent, pigment, additives, or hardener. In order to prepare the paint for use, this first paint component must be mixed with a second paint component 2 which is stored in a separate container 3. To ensure that the correct amounts of the components of the paint are mixed, a fill line is provided on the container 1 at a predetermined level such that, when a user fills the container with the second paint component to the fill line, the correct ratio of solvent, pigment, additives and hardener is provided. In this embodiment, the fill line is the base of the neck of the container, so that the container can simply be filled with the second paint component to the neck to ensure the correct ratios of paint components have been added. The container 1 is then closed and shaken to mix the solvent, pigment, additives or hardener, as shown in FIG. 1B. The container 1 is then mounted onto a spray gun 4 with the container 1 in an substantially inverted position, as shown in FIG. 1C, such that the paint contained therein is fed into the spray gun 4 under gravity. The system is thus known as a gravity feed system. In order to ensure proper sealing between the container 1 and the spray gun 4, an adaptor 7 is provided which mates to the container 1 and to the spray gun 4, thus providing a fluid connection there between.

The spray gun 4 combines paint from the container 1 with compressed air from a separate air compressor (not shown), which atomises the paint into a fine spray 5 and directs it to the target surface when the handle 6 of the spray gun 4 is depressed.

FIG. 2 is an exploded view of the spray gun and container according to a first embodiment of the present invention. The adaptor 7 is connected to the spray gun 4 via a first threaded connection 8, which allows the adaptor to be detached and replaced, if necessary. The adaptor 7 is provided with a second threaded connection 9 into which the opening of the container 1 can be inserted and threaded onto, thereby coupling the container to the spray gun.

A filter 10 is provided in the adaptor 7, such that paint is fed through the adaptor and passes through the filter to ensure that any impurities in the paint or the container do not enter the spray gun, which could affect the spray painting.

FIG. 3 shows the arrangement of FIG. 2 once assembled and ready for use. The container 1 is mounted onto the spray gun 4 via the adaptor 7, with the container 1 in a substantially inverted position such that the paint contained therein is fed to the spray gun 4 under gravity, via a paint outlet channel, as is discussed in further detail below.

FIG. 4 shows a cross section of the adaptor and container shown in the previous figures. The adaptor 7 contains an air inlet 11 for admitting air to the container 1 via an air inlet channel. A one-way valve 12 is located in the inlet 11 to prevent paint from the container 1 undesirably leaking out through the inlet 11. The paint is fed into the spray gun via the filter 10 through an outlet channel (not shown).

The one-way valve 12 allows air to flow in the direction of the arrow A into the container. Accordingly, as paint flows out of the container through the outlet channel, air passes into the container though the one-way valve 12 to equalise the pressure. As such, the paint can flow smoothly into the spray gun.

FIG. 5 shows a cross section of a second embodiment of the invention. This embodiment is similar to the first embodiment discussed above, except that tube 13 is further provided, connected to the air inlet 11. As with the first embodiment, a one-way valve 12 located in the inlet 11, which functions in the same way as the first embodiment described above with reference to FIG. 4.

When a container full of paint is first connected to the adaptor 7, the spray gun is inverted (as shown in FIG. 2) and tube 13 is lowered into the container 1, through the paint mix. The assembled spray gun and container is inverted, as shown in FIGS. 3 and 5, so that the tube 13 extends upwardly though the paint and its distal end is above the level of the paint 14 in the container 1. The inclusion of the tube 13 enables air to be admitted directly to the air cavity 15 in the container 1 above the paint level 14. This allows paint to be fed into the spray gun without air having to pass though the paint to enable the pressure in the container to be equalised. This advantageously ensures that paint is smoothly fed into the spray gun, and means that the integrity of the one-way valve is not as critical since paint cannot easily come into contact with the valve.

FIG. 6 shows a third embodiment of the invention which is similar to the second embodiment shown in FIG. 5. In this embodiment, however, the one-way valve 12 is located towards the distal end of the tube 13, such that when the system is in use the valve 12 is situated above the paint line 14. This arrangement is particularly preferred as it ensures that tube 13 is kept clear when the tube is first inserted through the paint as the container 1 is connected to the adaptor 7, and when the container is tilted on its side during a spraying operation.

FIG. 7 shows a fourth embodiment of the invention which is similar to the third embodiment shown in FIG. 6, with tube 13 forming an air inlet channel and the one-way valve 12 located at the distal end thereof. In this embodiment, however, the inlet 11 and tube 13 is configured, relative to the second threaded connection, such that, when the container 1 is attached, the distal end of the tube 13 extends to the vertical extremity of the container. This ensures that the tube extends fully into the air cavity in the container, which is created as paint from full container flows into the spray gun. Furthermore, by holding the inlet to tube 13 as high as possible above the paint level in the container, contact between the paint and the one-way-valve 12 is avoided. Consequently, a greater amount of paint can be held in the container with air still being admitted to the air cavity.

FIG. 8 is an exploded view of the container 1 mounted on the spray gun 4, showing each of the components disassembled. As is evident from FIG. 8, the components of the system, namely the gun, the container 1, the adaptor 7, the valve 10, and the tube 13, can be separated from one another allowing the components to be replaced, if necessary.

FIG. 9 shows a fifth embodiment of the invention which is similar to the third embodiment shown in FIG. 6. In this embodiment, a disposable one-way valve 12 construction is employed according to an embodiment of the invention, as will be discussed in more detail below.

FIGS. 10 and 11 respectively show a cross-sectional view and a end view of the one-way valve employed in the fifth embodiment shown in FIG. 9. The one-way valve 12 comprises two opposing sheet-like panels 15 which are bonded together at their lateral edges by joins 16. Base element 17 is provided bonded between the panels 15 at their bottom edge and provides an aperture into which tube 13 fits for allowing fluid communication between the tube 13 and the cavity formed between the panels by the base element 17. The top edge of the panels 16 remain un-bonded, thereby enabling the panels to separate to form an outlet channel through which air can pass.

The panels 16 are formed of a laminated foil sheet, which comprises a chemical resistant coating layer. This allows the valve to have a good, functional life-span, without suffering from premature degradation by the chemicals in the paint.

Furthermore, the relative stiffness provided by the foil and the laminated construction of this material enables the valve 12 to retain a generally planar shape in use, as is shown in the figures. Moreover, this stiffness also provides a level of shape memory in the panels 15. This, as well as the tapered construction formed by joins 16, helps to maintain the panels 15 in abutment against one another, and assists in returning the panels 15 to this closed position once pressure inside the container 1 has equalised. Moreover, in use, the air/paint pressure in the interior of the container 1 over the external surfaces of the panels 15 further acts to force and maintain the valve closed.

When paint is not flowing from the container 1, the valve remains in closed position, preventing passage of paint into the tube through the open end formed between the top of the panels 15.

When paint flows from the container 1, the fluid pressure in the interior of the container decreases below the external air pressure, and consequently the pressure inside the tube 13. This acts to draw air through the one-way valve 12. The air inside the tube 13 enters the cavity formed between the panels 15, causing the panels 15 to gape, separating them and opening the outlet formed between the top ends of the panels 15. This is shown in FIG. 11, which is a top view of one-way valve 15. As can be seen, the panels 15 separate, forming a channel between the panels 15 through which air from the tube 13 can pass into the interior of container 1 to equalise the pressure inside the container. When the flow of paint has stopped and the pressure has been equalised, the panels 15 return to their original shape, thereby closing the valve.

The above construction provides a simple, effective one-way valve. Importantly, as the valve is cheap and simple to manufacture, it allows the valve assembly to be provided as a disposable element. That is, the valve assembly can be attached to the tube 13 via a connection means provided at the aperture on its base 17. After a number of uses, the valve assembly can be detached and replaced. This is useful as one-way valves often clog or otherwise loose their effectiveness over time. Furthermore, within the context of the present application, when a user changes the paint color, they can simply replace the one-way valve, rather than having to clean it.

Moreover, the tall, substantially planar construction of the valve acts to protect the valve when the container is tilted during use. That is, during a spraying operation, it is common for a user to briefly tilt the spay gun on its side when they reach the end of a lateral spray movement to ensure that the side edges of an object have been properly covered in paint. This can result in the valve being dipped into the paint. However, with the above preferred construction, the paint easily slides of the sides of panels 15, reducing the likelihood of clogging and thereby ensuring efficient valve operation.

Although the present invention has been described in the above illustrated embodiments, the present invention is not limited solely to these particular embodiments and various modifications could be envisaged by the skilled person that fall within the scope of the present invention.

For example, in a further embodiment not shown in the drawings, the one-way valve may be situated at the distal end of the tube, similar to the third and fourth embodiments, but housed outside of the tube, such as that shown in the fifth embodiment.

Furthermore, although it is preferred to provide a one-way valve, embodiments are also envisaged which do not require a one-way valve. For example, the tube, like that as shown in the third and fourth embodiments illustrated in FIGS. 5 to 8, could be provided with a gravity valve or a simple lock off switch, provided at its distal end to prevent paint from entering the tube when it is first inserted into the container containing the paint. When the assembled container and spray gun is then inverted, the gravity valve or lock off switch could be opened to permit air to pass into the air cavity created in the container.

Furthermore, in the above embodiments, threaded couplings are described between the spray gun and adaptor, and the adaptor and container. However, it will be understood that other couplings, such as press fit or bayonet type couplings, could be used to facilitate connection.

Moreover, in the above embodiments, the adaptor has been described as a separate component from the spray gun, thereby permitting the attachment of the adaptor to a conventional spray gun. However, it will be understood that the adaptor may be formed integrally as part of the spray gun itself. Similarly, the components of the adaptor, such as the tube, filter and valve, may also be formed integrally.

Finally, although in the above examples the paint is formed by mixing a first paint component with a second paint component within the container, it will be understood that the present invention can also be used in conjunction with a container containing a ready mixed quantity of paint. That is, the connector of the present invention can be used to connect a pre-filled and premixed container of paint to a gravity feed spray paint gun.

1. A connector for connecting a paint container having an aperture to a gravity feed spray paint gun, the connector comprising:
a coupling for connection to the container's aperture and, in use, for mounting the container above the spray gun;
a paint feed channel for feeding paint from the container into the spray gun; and
an air feed channel for feeding air into the container as paint is fed into the spray gun,
wherein said air feed channel comprises a one-way valve comprising first and second opposing panels, the first panel being flexible and being connected to said second panel at or adjacent its lateral edges, said panels abutting against one another for preventing paint passing into the air feed channel and being moveable relative to one another into an open position for forming a fluid channel for fluid connection between the air feed channel and the interior of the container; and wherein, in use, when the air pressure in the air feed channel exceeds the pressure in the interior of the container, said panels move to said open position for opening said fluid channel.

2. A connector according to claim 1, wherein the second panel is flexible.

3. A connector according to claim 1, further comprising a tube for defining the air feed channel, the tube extending from the coupling such that, in use, it extends upward through the container=s aperture into the container.

4. A connector according to claim 3, wherein the one-way valve is located at the end of the tube distal to the connector element.

5. A connector according to claim 3, wherein the one-way valve further comprises a connector element provided between said first and second panels for connecting the tube to the fluid channel, wherein said connector element spaces said panels at their end closest to the tube, the panels being configured to taper inwardly towards their end distal to the connector element.

6. A connector according to claim 5, wherein the connections between the first and second panels taper inwardly from the end closest to the tube for forming a substantially conical tube when in an open position.

7. A connector according to claim 1, wherein the first and second panels are integrally formed.

8. A connector according to claim 1, wherein the first and second panels are formed of a laminated foil.

9. A connector according to claim 3, wherein the tube is configured such that, in use, it extends into the vertical extremity of the container.

10. A connector according to claim 1, further comprising a filter situated in the paint feed channel.

11. A connector according to claim 3, wherein at least one of the valve and/or tube are detachable from the connector.

12. A connector according to claim 10, wherein at least one of the valve and filter are detachable from the connector.

13. A connector according to claim 1, wherein the coupling comprises a threaded connector for connection to standard or substantially standard threading provided on the container's aperture.

14. A gravity feed spray gun comprising a connector as recited in claim 1.

15. A gravity feed spray gun according to claim 14, further comprising a detachable container.

16. A method of preparing a spray paint comprising the steps of:
providing a container with a required amount of a first paint component contained therein;
adding a required amount of a second paint component to the container;
mixing the components in the container;
mounting the container below a gravity feed spray gun using a connector, the connector comprising a coupling for connection to the container's aperture, a paint feed channel for feeding paint from the container into the spray gun, and an air feed channel for feeding air into the container as paint is fed into the spray gun, said air feed channel comprising a one-way valve comprising first and second opposing panels, the first panel being flexible and being connected to said second panel at or adjacent its lateral edges, said panels abutting against one another for preventing paint passing into the air feed channel and being moveable relative to one another into an open position for forming a fluid channel for fluid connection between the air feed channel and the interior of the container; and wherein, in use, when the air pressure in the air feed channel exceeds the pressure in the interior of the container, said panels move to said open position for opening said fluid channel, and
inverting the gun and container ready for spraying

17. A method of preparing a spray paint according to claim 16 wherein said first paint component comprises solvent, pigment, additives and/or hardener.

18. A method of preparing a spray paint according to claim 16 wherein said second paint component comprises at least one of solvent, pigment, additives and hardener.

19. (canceled)

20. (canceled)

21. (canceled)

22. (canceled)

23. (canceled)

24. (canceled)
